(19) United States
(12) Patent Application Publication
(10) Pub. No.: US 2026/0154125 A1
(43) Pub. Date: Jun. 4, 2026

(54) MEMORY MANAGEMENT METHOD AND MEMORY MANAGEMENT DEVICE

(71) Applicant: SAMSUNG ELECTRONICS CO., LTD., Suwon-si (KR)

(72) Inventors: Wenwen HAO, Suwon-si (KR); Yuqi ZHANG, Suwon-si (KR)

(73) Assignee: SAMSUNG ELECTRONICS CO., LTD., Suwon-si (KR)

(21) Appl. No.: 19/013,164

(22) Filed: Jan. 8, 2025

(30) Foreign Application Priority Data
Dec. 3, 2024 (CN) 202411764788.3

(51) Int. Cl. G06F 9/50; G06F 9/455

(52) U.S. Cl. CPC G06F 9/5077; G06F 9/45558; G06F 9/5016; G06F 2009/45583

(57) ABSTRACT

A memory management method includes predicting, based on an unused memory value and/or a latency sensitivity of at least one first virtual machine for which memory has been allocated, an unused memory value and/or a latency sensitivity of a second virtual machine for which memory is to be allocated, wherein the latency sensitivity of a respective virtual machine indicates whether the respective virtual machine is sensitive to a latency based on whether a latency condition indicating that the respective virtual machine is sensitive to latency is satisfied; and pre-allocating the memory to be allocated for the second virtual machine based on the predicted unused memory value and/or latency sensitivity of the second virtual machine.

### CROSS-REFERENCE TO RELATED APPLICATION

This application claims priority to Chinese Patent Application No. 202411764788.3, filed on Dec. 3, 2024, in the China National Intellectual Property Administration (CNIPA), the entire disclosure of which is incorporated herein by reference for all purposes.

### BACKGROUND

The present embodiments relate to computer technology and, more particularly, to a memory management method and a memory management device.

A virtual machine (VM) is a virtual environment created on a physical hardware system. A virtual machine can emulate its own set of virtualized hardware including a central processing unit (CPU), memory, network interface and storage.

For better use of a VM, the entire memory address space of the virtual machine is usually pre-allocated statically. Therefore, the server may allocate the maximum amount of memory to the virtual machine as needed. However, a large portion of a virtual machine's memory may not be accessed, and even when the memory is accessed, only a portion of the memory may be accessed frequently.

### SUMMARY

According to an aspect of the disclosure, a memory management method includes predicting, based on an unused memory value and/or a latency sensitivity of at least one first virtual machine for which a memory has been allocated, an unused memory value and/or a latency sensitivity of a second virtual machine for which memory is to be allocated, wherein the latency sensitivity of a respective virtual machine indicates whether the respective virtual machine is sensitive to a latency based on whether a latency condition indicating that the respective virtual machine is sensitive to latency is satisfied; and pre-allocating the memory to be allocated for the second virtual machine based on the predicted unused memory value and/or latency sensitivity of the second virtual machine.

According to an aspect of the disclosure, the predicting the unused memory value and/or the latency sensitivity of the second virtual machine for which the memory is to be allocated further includes: determining at least one similarity between (i) memory usage information of the at least one first virtual machine and (ii) memory usage information of the second virtual machine, wherein memory usage information of the respective virtual machine includes one or more of (a) an identity of a customer corresponding to the respective virtual machine, (b) a type of application corresponding to the respective virtual machine, (c) a location of the customer, (d) information of a processor specified by the respective virtual machine, and (e) information of a memory specified by the respective virtual machine; and predicting the unused memory value and/or the latency sensitivity of the second virtual machine based on the at least one similarity and the unused memory value and/or the latency sensitivity of the at least one first virtual machine.

According to an aspect of the disclosure, the at least one first virtual machine includes n first virtual machines, wherein n is a positive integer, wherein the predicting the unused memory value of the second virtual machine further includes: allocating n weights respectively to n unused memory values of the n first virtual machines based on n similarities between n memory usage information of the n first virtual machines, respectively, and the memory usage information of the second virtual machine; and predicting an unused memory estimation value for the second virtual machine by performing a weighted average calculation based on the n unused memory values of the n first virtual machines and the n weights corresponding to the n unused memory values.

According to an aspect of the disclosure, the predicting the latency sensitivity of the second virtual machine includes: determining whether one or more first virtual machines of the at least one first virtual machine are sensitive to the latency in response to the similarity indicating that the memory usage information of the second virtual machine is the same as memory usage information of the one or more first virtual machines; predicting the latency sensitivity of the second virtual machine to be sensitive to latency in response to a number of first virtual machines in the one or more first virtual machines that are sensitive to the latency being greater than or equal to half of the number of the one or more first virtual machines; and predicting the latency sensitivity of the second virtual machine to be insensitive to latency in response to the number of first virtual machines in the one or more first virtual machines that are sensitive to the latency being smaller than the half of the number of the one or more first virtual machines.

According to an aspect of the disclosure, the pre-allocating the memory to be allocated for the second virtual machine further includes: pre-allocating, in response to the latency sensitivity in the unused memory value and the predicted latency sensitivity of the second virtual machine indicating that the second virtual machine is sensitive to the latency, the memory to be allocated for the second virtual machine into local memory; pre-allocating, in response to the unused memory value indicating the second virtual machine is sensitive to latency, predicted unused memory corresponding to the predicted unused memory value of the second virtual machine in the memory to be allocated for the second virtual machine into a pool memory and pre-allocating remaining memory in the memory to be allocated for the second virtual machine, other than the predicted unused memory, into the local memory; and/or pre-allocating, in response to both the unused memory value and the predicted latency sensitivity of the second virtual machine indicating that the second virtual machine is insensitive to the latency, the predicted unused memory in the memory to be allocated for the second virtual machine into the pool memory and pre-allocating remaining memory in the memory to be allocated for the second virtual machine, other than the predicted unused memory, into the local memory.

According to an aspect of the disclosure, the memory management method further includes: determining whether the unused memory in the allocated memory of the second virtual machine is overestimated by comparing an actual unused memory of the second virtual machine, which is monitored while the second virtual machine runs, with the unused memory in the allocated memory of the second virtual machine; estimating whether the second virtual machine is sensitive to the latency in response to determining that the unused memory in the allocated memory of the second virtual machine is overestimated; and reallocating the used memory of the second virtual machine into local memory in response to the second virtual machine being estimated to be sensitive to latency.

According to an aspect of the disclosure, the estimating whether the second virtual machine is sensitive to the latency further includes: obtaining core performance measurement unit metrics for the at least one first virtual machine and core performance measurement unit metrics for the second virtual machine; determining N virtual machines in the at least one first virtual machine that are most similar to the second virtual machine in terms of latency-related information by comparing the core performance measurement unit metrics of the at least one first virtual machine with the core performance measurement unit metrics of the second virtual machine, wherein n is a positive integer; and determining whether the second virtual machine is sensitive to latency based on determining that a number of the virtual machines having a sensitive to a latency label among the N virtual machines is greater than or equal to a threshold.

According to an aspect of the disclosure, the memory management method further includes: clustering, in response to the second virtual machine being estimated to be insensitive to latency, data of the second virtual machine stored in local memory a plurality of groups according to a program context and one or more access counts of an application on the second virtual machine; and storing one or more of the plurality of groups with a lowest average number of accesses in a pool memory and/or storing one or more of the plurality of groups with a highest average number of accesses in local memory.

According to an aspect of the disclosure, the at least one first virtual machine is n virtual machines, among a plurality of first virtual machines for which a memory has been allocated, having memory usage information that is most similar to the memory usage information of the second virtual machine, wherein n is a positive integer, and wherein the memory usage information of the virtual machine includes one or more of the identity of a customer corresponding to the virtual machine, a type of application corresponding to the virtual machine, a location of the customer, information of a processor specified by the virtual machine, and information of memory specified by the virtual machine.

According to an aspect of the disclosure, a memory management device includes: a memory storing one or more instructions; and a processor operatively coupled to the memory and configured to execute the one or more instructions, wherein, when the processor executes the one or more instructions, the memory management device is configured to: predict, based on an unused memory value and/or a latency sensitivity of at least one first virtual machine for which a memory has been allocated, an unused memory value and/or a latency sensitivity of a second virtual machine for which memory is to be allocated, wherein the latency sensitivity of a respective virtual machine indicates whether the respective virtual machine is sensitive to a latency based on whether a latency condition indicating that the respective virtual machine is sensitive to latency is satisfied; and pre-allocate the memory to be allocated for the second virtual machine based on the predicted unused memory value and/or latency sensitivity of the second virtual machine.

According to an aspect of the disclosure, wherein the one or more instructions, when executed by the processor to predict the unused memory value and/or the latency sensitivity of the second virtual machine for which the memory is to be allocated, further cause the memory management device to: determine at least one similarity between (i) memory usage information of the at least one first virtual machine and (ii) memory usage information of the second virtual machine, wherein memory usage information of the respective virtual machine includes one or more of (a) an identity of a customer corresponding to the respective virtual machine, (b) a type of application corresponding to the respective virtual machine, (c) a location of the customer, (d) information of a processor specified by the respective virtual machine, and (e) information of a memory specified by the respective virtual machine, and predict the unused memory value and/or the latency sensitivity of the second virtual machine based on the at least one similarity and the unused memory value and/or the latency sensitivity of the at least one first virtual machine.

According to an aspect of the disclosure, the at least one first virtual machine comprise n first virtual machines, wherein n is a positive integer, wherein the one or more instructions, when executed by the processor to predict the unused memory value of the second virtual machine, further cause the memory management device to: allocate n weights respectively to n unused memory values of the n first virtual machines based on n similarities between n memory usage information of the n first virtual machines, respectively, and the memory usage information of the second virtual machine, and predict an unused memory estimation value for the second virtual machine by performing a weighted average calculation based on the n unused memory values of the n first virtual machines and the n weights corresponding to the n unused memory values.

According to an aspect of the disclosure, the one or more instructions, when executed by the processor to predict the latency sensitivity of the second virtual machine, further cause the memory management device to: determine whether one or more first virtual machines of the at least one first virtual machine are sensitive to the latency in response to the similarity indicating that the memory usage information of the second virtual machine is the same as memory usage information of the one or more first virtual machines, predict the latency sensitivity of the second virtual machine to be sensitive to latency in response to a number of first virtual machines in the one or more first virtual machines that are sensitive to the latency being greater than or equal to half of the number of the one or more first virtual machines, and predict the latency sensitivity of the second virtual machine to be insensitive to latency in response to the number of first virtual machines in the one or more first virtual machines that are sensitive to the latency being smaller than the half of the number of the one or more first virtual machines.

According to an aspect of the disclosure, wherein the one or more instructions, when executed by the processor to pre-allocate the memory to be allocated for the second virtual machine, further cause the memory management device to: pre-allocate, in response to the latency sensitivity in the unused memory value and the predicted latency sensitivity of the second virtual machine indicating that the second virtual machine is sensitive to the latency, the memory to be allocated for the second virtual machine into local memory; pre-allocate, in response to the unused memory value indicating the second virtual machine is sensitive to latency, predicted unused memory corresponding to the predicted unused memory value of the second virtual machine in the memory to be allocated for the second virtual machine into a pool memory and pre-allocating remaining memory in the memory to be allocated for the second virtual machine, other than the predicted unused memory, into the local memory, and/or pre-allocate, in response to both the unused memory value and the predicted latency sensitivity of the second virtual machine indicating that the second virtual machine is insensitive to the latency, the predicted unused memory in the memory to be allocated for the second virtual machine into the pool memory and pre-allocating remaining memory in the memory to be allocated for the second virtual machine, other than the predicted unused memory, into the local memory.

According to an aspect of the disclosure, wherein the one or more instructions, when executed by the processor, further cause the memory management device to: determine whether the unused memory in the allocated memory of the second virtual machine is overestimated by comparing an actual unused memory of the second virtual machine, which is monitored while the second virtual machine runs, with the unused memory in the allocated memory of the second virtual machine, estimate whether the second virtual machine is sensitive to the latency in response to determining that the unused memory in the allocated memory of the second virtual machine is overestimated, and reallocate the used memory of the second virtual machine into the local memory in response to the second virtual machine being estimated to be sensitive to latency.

According to an aspect of the disclosure, wherein the one or more instructions, when executed by the processor to estimate whether the second virtual machine is sensitive to the latency, further cause the memory management device to: obtain core performance measurement unit metrics for the at least one first virtual machine and core performance measurement unit metrics for the second virtual machine, determine N virtual machines in the at least one first virtual machine that are most similar to the second virtual machine in terms of latency-related information by comparing the core performance measurement unit metrics of the at least one first virtual machine with the core performance measurement unit metrics of the second virtual machine, wherein n is a positive integer, and determine whether the second virtual machine is sensitive to latency based on determining that a number of the virtual machines having a sensitive to a latency label among the N virtual machines is greater than or equal to a threshold.

According to an aspect of the disclosure, wherein the one or more instructions, when executed by the processor, further cause the memory management device to: cluster, in response to the second virtual machine being estimated to be insensitive to latency, data of the second virtual machine stored in local memory a plurality of groups according to a program context and one or more access counts of an application on the second virtual machine, and store one or more of the plurality of groups with a lowest average number of accesses in a pool memory and/or storing one or more of the plurality of groups with a highest average number of accesses in the local memory.

According to an aspect of the disclosure, wherein the at least one first virtual machine is n virtual machines, among a plurality of first virtual machines for which a memory has been allocated, having memory usage information that is most similar to the memory usage information of the second virtual machine, wherein n is a positive integer, and wherein the memory usage information of the virtual machine includes one or more of the identity of a customer corresponding to the virtual machine, a type of application corresponding to the virtual machine, a location of the customer, information of the processor specified by the virtual machine, and information of memory specified by the virtual machine.

According to an aspect of the disclosure, a non-transitory computer-readable storage medium having instructions stored therein, which, when executed by a processor, causes the processor to execute a method including: predicting, based on an unused memory value and/or a latency sensitivity of at least one first virtual machine for which a memory has been allocated, an unused memory value and/or a latency sensitivity of a second virtual machine for which memory is to be allocated, wherein the latency sensitivity of a respective virtual machine indicates whether the respective virtual machine is sensitive to a latency based on whether a latency condition indicating that the respective virtual machine is sensitive to latency is satisfied; and pre-allocating the memory to be allocated for the second virtual machine based on the predicted unused memory value and/or latency sensitivity of the second virtual machine.

According to an aspect of the disclosure, the predicting the unused memory value and/or the latency sensitivity of the second virtual machine for which the memory is to be allocated further includes: determining at least one similarity between (i) memory usage information of the at least one first virtual machine and (ii) memory usage information of the second virtual machine, wherein memory usage information of the respective virtual machine includes one or more of (a) an identity of a customer corresponding to the respective virtual machine, (b) a type of application corresponding to the respective virtual machine, (c) a location of the customer, (d) information of a processor specified by the respective virtual machine, and (e) information of a memory specified by the respective virtual machine; and predicting the unused memory value and/or the latency sensitivity of the second virtual machine based on the at least one similarity and the unused memory value and/or the latency sensitivity of the at least one first virtual machine.

### BRIEF DESCRIPTION OF THE DRAWINGS

The above and other objects and features of the present embodiments will become clearer by the following description in conjunction with the accompanying drawings showing an example, wherein:

FIG. 1 illustrates a flowchart of a memory management method according to example embodiments of the present disclosure.

FIG. 2 illustrates a flowchart of a method for predicting an unused memory value and/or a latency sensitivity of a second virtual machine for which memory is to be allocated, according to example embodiments of the present disclosure.

FIG. 3 illustrates a flowchart of a method for predicting a latency sensitivity of a second virtual machine for which memory is to be allocated, according to example embodiments of the present disclosure.

FIG. 4 illustrates a flowchart of a method of pre-allocating memory to be allocated for a second virtual machine according to example embodiments of the present disclosure.

FIG. 5 illustrates a flowchart of a memory management method according to example embodiments of the present disclosure.

FIG. 6 illustrates a flowchart of a memory management method according to example embodiments of the present disclosure.

FIG. 7 illustrates a flowchart of a memory management method according to example embodiments of the present disclosure.

FIG. 8 illustrates a schematic diagram of a virtual machine server according to example embodiments of the present disclosure.

FIG. 9 illustrates a schematic diagram of a memory management method according to example embodiments of the present disclosure.

FIG. 10 illustrates a schematic diagram of memory pre-allocation according to example embodiments of the present disclosure.

FIG. 11 illustrates a schematic diagram of a similarity-based unused memory estimation method according to example embodiments of the present disclosure.

FIG. 12 illustrates a schematic diagram of memory reallocation and group-based data exchange (or swapping) according to example embodiments of the present disclosure.

FIG. 13 illustrates a schematic diagram for estimating a sensitivity of a virtual machine, according to example embodiments of the present disclosure.

FIG. 14 illustrates a schematic diagram of group-based data exchange according to example embodiments of the present disclosure.

FIG. 15 illustrates a schematic diagram of clustering data into groups according to example embodiments of the present disclosure.

FIG. 16 illustrates a flowchart of a memory pre-allocation and a memory reallocation according to example embodiments of the present disclosure.

FIG. 17 illustrates a flowchart of group-based data exchange according to example embodiments of the present disclosure.

FIG. 18 illustrates a block diagram of a memory management device according to example embodiments of the present disclosure.

FIG. 19 is a block diagram of an example computer system, in accordance with embodiments of the present disclosure.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component is described as being “connected to” or “coupled to” another component, it may be directly “connected to” or “coupled to” the other component, or there may be one or more other components intervening therebetween. In contrast, when an element is described as being “directly connected to” or “directly coupled to” another element, there can be no other elements intervening therebetween. Likewise, similar expressions, for example, “between” and “immediately between” and “adjacent to” and “immediately adjacent to” are also to be construed in the same way. As used herein, the term “and/or” includes any one and any combination of any two or more of the associated listed items.

Although terms such as “first” “second” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The terminology used herein is for describing various examples only and is not to be used to limit the disclosure. The articles “a” “an” and “the” are intended to include the plural forms as well, unless the context clearly indicates otherwise. The terms “comprises” “includes” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art for which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment (e.g., as to what an example or embodiment may include or implement) means that at least one example or embodiment exists where such a feature is included or implemented, while all examples are not limited thereto.

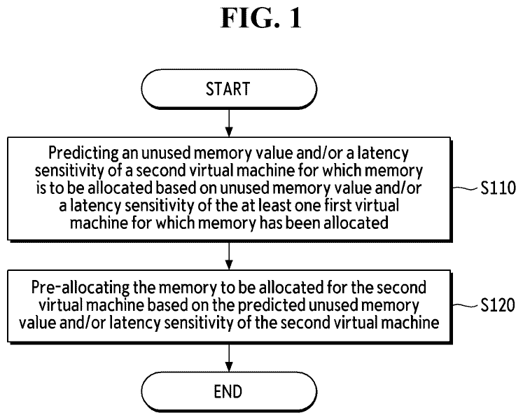

FIG. 1 illustrates a flowchart of a memory management method according to example embodiments of the present disclosure.

Referring to FIG. 1, in operation S110, an unused memory (UM) value and/or a latency sensitivity of a second virtual machine for which memory is to be allocated may be predicted based on an unused memory value and/or a latency sensitivity of at least one first virtual machine for which memory has been allocated, in which the latency sensitivity of the virtual machine indicates whether or not the virtual machine is sensitive to latency.

Since the unused memory value and/or the latency sensitivity of the at least one first virtual machine for which memory has been allocated is used as a basis for predicting the unused memory value and/or the latency sensitivity of the second virtual machine for which the memory is to be allocated, the unused memory value and/or the latency sensitivity of the second virtual machine for which the memory is to be allocated may be accurately predicted.

The unused memory value for the second virtual machine for which the memory is to be allocated may be a value used to reflect a percentage of memory that will not be accessed by the new virtual machine at the time the memory is pre-allocated (e.g., the unused memory value may be a percentage value). In one or more examples, for a reference virtual machine (e.g., the at least one first virtual machines), the unused memory value for the reference virtual machine may be obtained by scanning the access bits of the hypervisor page table during the life cycle of the reference virtual machine. However, the manner of obtaining the unused memory value for the reference virtual machine is not limited thereto, and the unused memory value for the reference virtual machine may be obtained in any existing method. Data that is obtained from the reference virtual machine and used for a prediction for another virtual machine may be referred to as reference data or history data.

The latency sensitivity may be indicated by a sensitivity label of the virtual machine. The sensitivity label of the reference virtual machine may be manually or automatically labeled as sensitive or insensitive to the latency. For example, the sensitivity label of the reference virtual machine may be labeled as sensitive or insensitive to the latency based on one or more of the following conditions: workload performance of the reference virtual machine throughout whole lifecycle, operational experience, offline experimental results, or any other suitable conditions that indicate latency sensitivity. For example, the sensitivity label of the virtual machine may be labeled with a first value or a second value, in which the first value indicates that the virtual machine is sensitive to the latency (e.g., memory latency) and the second value indicates that the virtual machine is not sensitive to the latency. In one or more examples, the latency sensitivity may be based on a workload performance of a virtual machine. For example, if a workload increases by a predetermined amount, and the latency of the virtual machine (e.g., the amount of time required to process one or more tasks) increases by a percentage that is greater than a predetermined percentage (e.g., 5%-10%), the virtual machine may be determined to be latency sensitive. However, if the workload increases by the predetermined amount, and the latency of the virtual machine does not increase or increases by a percentage that is less than or equal to the predetermined percentage, the virtual machine may be determined to be not latency sensitive (e.g., latency insensitive). The workload performance is an example of a latency condition, where when the latency condition is satisfied, a virtual machine may be determined to be sensitive to latency.

In one or more embodiments, the at least one first virtual machine is n virtual machines, among the plurality of first virtual machines for which memory has been allocated, that are most similar to the second virtual machine in terms of memory usage information, in which n is a positive integer. For example, the memory usage information of the virtual machine may include one or more of an identity of a customer corresponding to the virtual machine, a type of application corresponding to the virtual machine, a location of the customer (e.g., a city and a region, etc.), information of a processor (e.g., a central processing unit (CPU), a graphics processing unit (GPU), a neural processor (NPU), etc.) required or specified by the virtual machine, information of the memory required or specified by the virtual machine (e.g., a memory size, type, etc.), or any other suitable memory usage information known to one or ordinary skill in the art. In one or more embodiments, since the unused memory value and/or the latency sensitivity of the second virtual machine for which the memory is to be allocated may be predicted based on the unused memory values and/or the latency sensitivities of the n virtual machines that are most similar to the second virtual machine in terms of the memory usage information, it is possible to more accurately predict the unused memory value and/or the latency sensitivity of the second virtual machine for which the memory is to be allocated. In one or more examples, a first virtual machine is similar to a second virtual machine when one or more pieces of memory usage information of the first virtual machine matches one or more pieces of memory usage information of the second virtual machine.

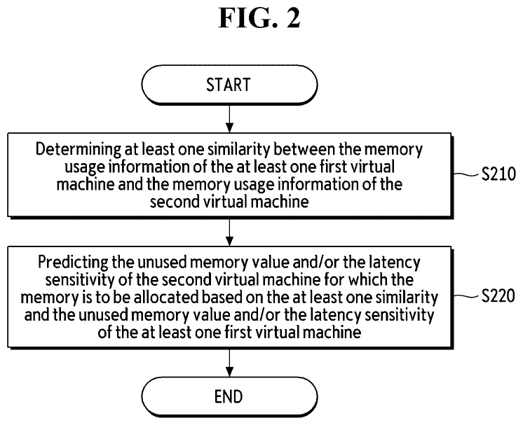

The operation S110 will be described more specifically later in connection with FIG. 2.

In operation S120, the memory to be allocated for the second virtual machine may be pre-allocated based on the predicted unused memory value and/or latency sensitivity of the second virtual machine.

As discussed above, since the unused memory value and/or the latency sensitivity of the at least one first virtual machine for which the memory has been allocated is used as a basis for predicting the unused memory value and/or the latency sensitivity of the second virtual machine for which the memory is to be allocated, the unused memory value and/or the latency sensitivity of the second virtual machine for which the memory is to be allocated may be accurately predicted. Thus, compared to the prior art where the entire memory address space corresponding to the maximum amount of the memory of the virtual machine must be pre-allocated statically, it is more reasonable to pre-allocate the memory of the second virtual machine based on the accurately predicted unused memory value and/or the latency sensitivity of the second virtual machine for which the memory is to be allocated, which reduces the possibility of the memory being left unused.

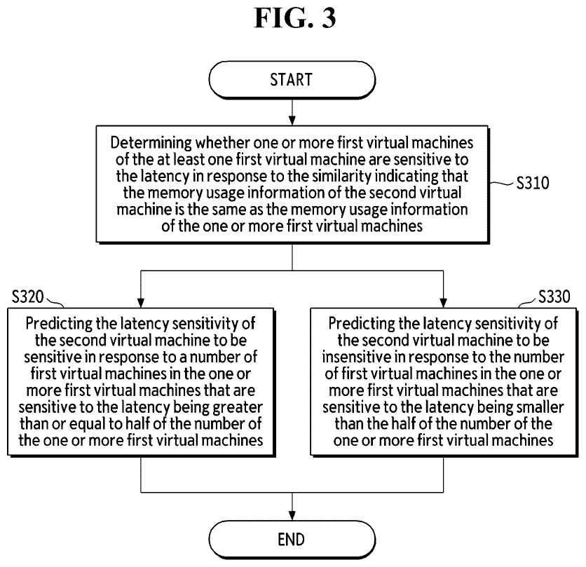

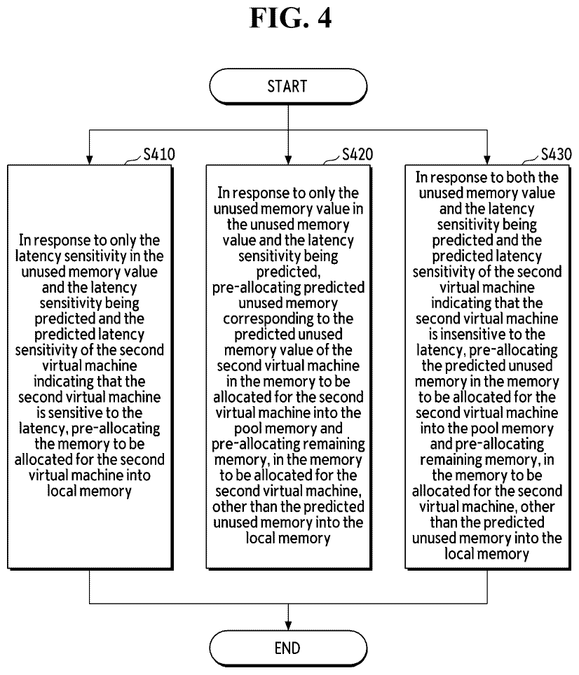

The method of pre-allocating the memory to be allocated for the second virtual machine will be described more specifically below in connection with FIGS. 3 to 4.

FIG. 2 illustrates a flowchart of a method for predicting the unused memory value and/or the latency sensitivity of a second virtual machine for which memory is to be allocated, according to example embodiments of the present disclosure.

Referring to FIG. 2, in operation S210, at least one similarity between the memory usage information of the at least one first virtual machine and the memory usage information of the second virtual machine may be determined.

The memory usage information of the virtual machine may include one or more of an identity of a customer corresponding to the virtual machine, a type of application corresponding to the virtual machine, a location of the customer, information of a processor required or specified by the virtual machine, and information of a memory required or specified by the virtual machine.

In one or more examples, the similarity between the two virtual machines may be the inverse of a Euclidean distance between the two virtual machines. However, the measure of similarity between the two virtual machines is not limited to this method and may be determined using any other similarity representation. In the example of using the Euclidean distance to determine the similarity, the calculation of the Euclidean distance may be slightly modified since there may be string-type features (e.g., customer ID and application type) for the memory usage information of the virtual machines. For string-type features, the feature differences may be defined as 0 (string attribute values are same), 1 (string attribute values are not same). For example, the memory usage information may include attribute 1 (e.g. customer ID), attribute 2 (e.g., application type), and attribute 3 (information of a processor). If attributes 1 and 2 between two virtual machines match, and attribute 3 does not match, the string value may be 001. The string value may be converted to a coordinate or reference number, where the Euclidean distance may be determined between the coordinate or reference number and a reference point (e.g., coordinate (0,0) on a 2D graph. In one or more examples, the Euclidean distance may be determined as d(p, q)=√(p−q)².

The operation S210 will be described more specifically later in connection with FIG. 3.

In operation S220, the unused memory value and/or the latency sensitivity of the second virtual machine for which memory is to be allocated may be predicted based on the at least one similarity and the unused memory value and/or the latency sensitivity of the at least one first virtual machine.

Even with a small amount of reference virtual machine data, similarity-based prediction of unused memory value and/or the latency sensitivity of the second virtual machine for which memory is to be allocated may yield good results. Furthermore, the performance of the similarity-based method of predicting the unused memory value and/or the latency sensitivity of the second virtual machine of the memory to be allocated is less affected by changes in the data distribution compared to conventional machine learning methods.

In one or more embodiments, the one or more first virtual machines comprise n first virtual machines, in which n is a positive integer. In one or more examples, n weights may be assigned to the n unused memory values of the n virtual machines based on n similarities between the n memory usage information of the n first virtual machines and the memory usage information of the second virtual machine, respectively.

Various methods may be used to calculate and/or define the similarities and assign weights based on the similarities. In one or more examples, when the similarity between the memory usage information of the first virtual machine and the memory usage information of the second virtual machine indicates that the first virtual machine has the same specific memory usage information (e.g., by way of example only, one or more of a customer ID, an application type corresponding to the virtual machine, a location of the customer, information about a processor required or specified by the virtual machine, and information about memory required or specified by the virtual machine) as the second virtual machine, a first weight is assigned to the unused memory value of the first virtual machine; and when the similarity between the memory usage information indicates that the first virtual machine does not have the same specific memory usage information as the second virtual machine, a second weight is assigned to the unused memory value of the first virtual machine, in which the first weight is greater than the second weight. In another example, when the similarity between the memory usage information of the first virtual machine and the memory usage information of the second virtual machine is computed by a similarity representation method (e.g., a similarity representation method based on Euclidean distances), if the similarity between the memory usage information of the first virtual machine and the memory usage information of the second virtual machine indicates a first similarity, a first weight may be assigned to the unused memory value of the first virtual machine and if the similarity between the memory usage information of the first virtual machine and the memory usage information of the second virtual machine indicates a second similarity that is less than the first similarity, a second weight may be assigned to the unused memory value of the first virtual machine, in which the first weight is greater than the second weight. In this other example, the unused memory value of the second virtual machine may be predicted more accurately because the first virtual machine having the large similarity is assigned a relatively large weight. However, the above example is exemplary, and weights may be assigned in various other ways based on similarity between memory usage information.

The unused memory estimation value for the second virtual machine may be predicted by performing a weighted average calculation based on n unused memory values for n first virtual machines and n weights corresponding to the n unused memory values.

For example, when n=2, the one or more first virtual machines include two first virtual machines (e.g., a first reference virtual machine and a second reference virtual machine). A weight (e.g., a first weight) may be assigned to a first unused memory value of the first reference virtual machine based on a comparison result between the memory usage information of the second virtual machine and the memory usage information of the first reference virtual machine. A weight (e.g., a second weight) may be assigned to a second unused memory value of the second reference virtual machine based on a comparison result between the memory usage information of the second virtual machine and the memory usage information of the second reference virtual machine. The first weight and the second weight may be the same or different. The unused memory estimation value for the second virtual machine may be predicted by performing a weighted average calculation based on the first unused memory value, the first weight, the second unused memory value, and the second weight. For example, the unused memory estimation value=(first unused memory value×first weight+second unused memory value×second weight)/(first weight+second weight).

However, the number of the one or more first virtual machines is not limited thereto, and the one or more first virtual machines may include three or more reference virtual machines. The calculation of the unused memory estimation value for the second virtual machine in the case where the one or more first virtual machines may include three or more reference virtual machines may be similar to the calculation of the unused memory estimation value for the second virtual machine in the case where the one or more first virtual machines include a first reference virtual machine and a second reference virtual machine. For example, in the case where the one or more first virtual machines may include three reference virtual machines (e.g., a first reference virtual machine, a second reference virtual machine, and a third reference virtual machine), the unused memory estimation value=(first unused memory value×first weight+second unused memory value×second weight+third unused memory value×third weight)/(first weight+second weight+third weight).

FIG. 3 illustrates a flowchart of a method for predicting a latency sensitivity of a second virtual machine for which memory is to be allocated according to an example embodiment of the present disclosure.

Referring to FIG. 3, in operation S310, whether one or more first virtual machines of the at least one first virtual machine are sensitive to the latency may be determined in response to a similarity indicating that the memory usage information of the second virtual machine is the same as the memory usage information of the one or more first virtual machines.

For example, when a reference virtual machine and new virtual machine have a same memory usage information, whether the one or more first virtual machines are sensitive to the latency may be determined.

In operation S320, the latency sensitivity of the second virtual machine may be predicted to be sensitive in response to a number of first virtual machines in the one or more first virtual machines that are sensitive to the latency being greater than or equal to half of the number of the one or more first virtual machines. For example, when there are 5 first virtual machines, the second virtual machine may be determined to be sensitive to latency when 3 of the 5 first virtual machines are sensitive to latency.

When there is only one reference virtual machine that is the same as the second virtual machine in terms of memory usage information and the latency sensitivity of the one reference virtual machine is sensitive, the latency sensitivity of the second virtual machine is predicted to be sensitive. When there are a plurality of reference virtual machines that are same as the second virtual machine in terms of memory usage information and the latency sensitivities of a majority of the plurality of reference virtual machines are sensitive, the latency sensitivity of the second virtual machine is predicted to be sensitive.

In operation S330, the latency sensitivity of the second virtual machine is predicted to be insensitive in response to the number of first virtual machines in the one or more first virtual machines that are sensitive to the latency being smaller than the half of the number of the one or more first virtual machines.

When there is only one reference virtual machine that is the same as the second virtual machine in terms of memory usage information and the latency sensitivity of the one reference virtual machine is insensitive, the latency sensitivity of the second virtual machine is predicted to be insensitive. When there are a plurality of reference virtual machines that are same as the second virtual machine in terms of memory usage information and the latency sensitivities of a majority of the plurality of reference virtual machines are insensitive, the latency sensitivity of the second virtual machine is predicted to be insensitive.

The method of predicting the latency sensitivity of the second virtual machine for which memory is to be allocated, according to example embodiments, may accurately predict the latency sensitivity of the second virtual machine based on latency sensitivities of one or more first virtual machines that are the same as the second virtual machine in terms of memory usage information.

FIG. 4 illustrates a flowchart of a method of pre-allocating memory to be allocated for the second virtual machine according to an example embodiment of the present disclosure.

Referring to FIG. 4, in operation S410, the memory to be allocated for the second virtual machine may be pre-allocated into local memory in response to only the latency sensitivity being predicted in the unused memory value and the latency sensitivity and the predicted latency sensitivity of the second virtual machine indicating that the second virtual machine is sensitive to the latency.

As understood by one of ordinary skill in the art, the local memory may have a lower latency. Accordingly, the latency of the memory of the second virtual machine may be minimized by pre-allocating the memory that is sensitive to latency into the local memory.

Operation S410 may correspond to one or more embodiments that only predicts the latency sensitivity of the second virtual machine for which the memory is to be allocated.

In operation S420, in response to only the unused memory value in the unused memory value and latency sensitivity being predicted, memory corresponding to the predicted unused memory value of the second virtual machine in the memory to be allocated for the second virtual machine may be pre-allocated into the pool memory and remaining memory, in the memory to be allocated for the second virtual machine, other than memory corresponding to the predicted unused memory value may be pre-allocated into the local memory.

The pool memory may have a larger storage capacity and relatively high latency compared to the local memory. Therefore, by pre-allocating the memory corresponding to the predicted unused memory value of the second virtual machine in the memory to be allocated for the second virtual machine into the pool memory, the storage space of the local memory may be saved, and at the same time, there is less of a problem of idling of the local memory. In one or examples, memory idling refers to how much a device's memory is used when the device is idle.

Operation S420 may correspond to one or more embodiments in which only the unused memory value of the second virtual machine for which memory is to be allocated is predicted.

In one or more examples, the local memory and pool memory may be local memory and pool memory in a Compute Express Link (CXL)-Memory Expander (MXP)-based memory pooling system, in which workloads of the customer are deployed in the form of the virtual machines. Compute Express Link is an interconnect standard that supports cacheable load/store access to the pool memory with nanosecond latency. Compute express link memory (e.g., the pool memory) is virtualized using hypervisor page tables and memory management units, and thus, may be accessed like local memory (e.g., as an example only, local DRAM). In one or more examples, the compute express link may provide the virtual machine with a shared memory pool as a secondary memory, and the pool memory in the shared memory pool may be dynamically reallocated into different hosts.

However, the above examples are merely exemplary, and the local memory and the pool memory may also be any other local memory and pool memory, in which the local memory has a lower latency, and the pool memory typically has a larger storage capacity and a relatively high latency compared to the local memory.

In operation S430, in response to both the unused memory value and the latency sensitivity being predicted and the predicted latency sensitivity of the second virtual machine indicating that the second virtual machine is insensitive to the latency, the memory corresponding to the predicted unused memory value of the second virtual machine in the memory to be allocated for the second virtual machine may be pre-allocated into the pool memory and remaining memory, in the memory to be allocated for the second virtual machine, other than memory corresponding to the predicted unused memory value may be pre-allocated into the local memory.

The operation S430 may correspond to the embodiment of predicting the unused memory value and the latency sensitivity of the second virtual machine for which the memory is to be allocated.

The examples or embodiments described above may be combined in various ways. For example, one or more of operation S410, operation S420, and operation S430 may be performed.

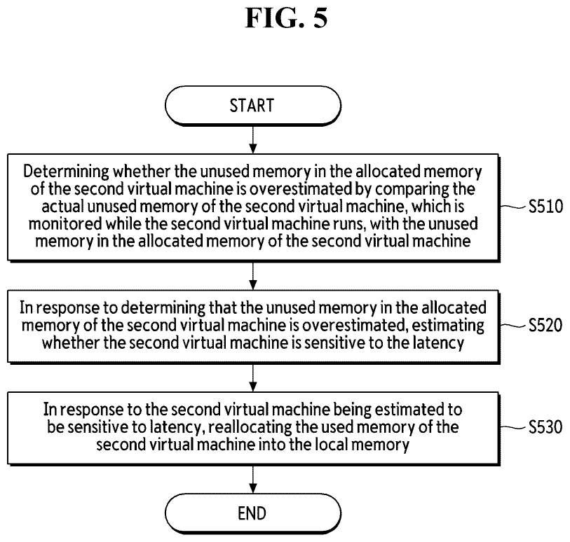

FIG. 5 illustrates a flowchart of a memory management method according to example embodiments of the present disclosure.

Referring to FIG. 5, in operation S510, whether the unused memory in the allocated memory of the second virtual machine is overestimated is determined by comparing the actual unused memory of the second virtual machine, which is monitored while the second virtual machine runs, with the unused memory in the allocated memory of the second virtual machine.

For example, it may be monitored whether the unused memory in the allocated memory of the second virtual machine is overestimated at whole runtime of the second virtual machine. If the unused memory is overestimated in the memory pre-allocation process, the second virtual machine must store some of its data on the pool memory. Since the access latency of the pool memory may have different influences on different virtual machines, the memory allocation operation may be performed further considering the latency of the virtual machine to meet the latency requirements or conditions of the virtual machine. In or more examples, the unused memory is overestimated when the unused memory is predetermined amount (e.g., 100 Mb) or percentage (e.g., 5%) over a predicted amount of unused memory.

In one or more examples, in response to the monitored actual unused memory of the second virtual machine being significantly less than the unused memory in the allocated memory of the second virtual machine, the unused memory in the allocated memory of the second virtual machine may be determined to be overestimated. Here, significantly less than may be set as needed for design purposes. For example, significantly less than may indicate that the monitored actual unused memory of the second virtual machine is smaller than the unused memory in the allocated memory of the second virtual machine by at least a predetermined value or a predetermined percentage.

In operation S520, in response to determining that the unused memory in the allocated memory of the second virtual machine is overestimated, it is estimated that whether the second virtual machine is sensitive to latency.

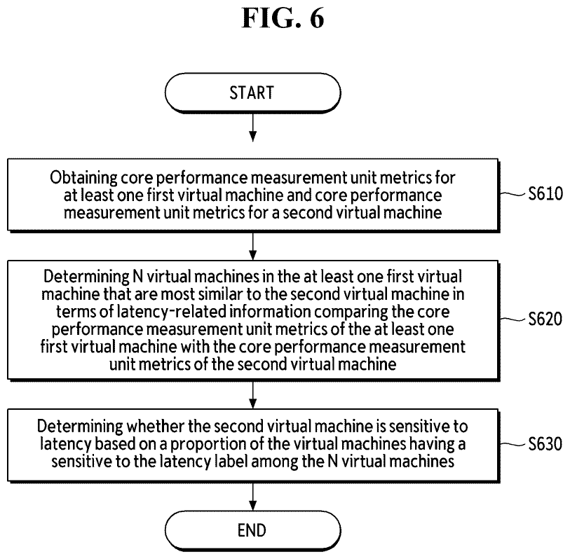

The method of estimating whether the second virtual machine is sensitive to the latency will be described below with reference to FIG. 6.

In operation S530, in response to the second virtual machine being estimated to be sensitive to latency, the unused memory of the second virtual machine is reallocated into the local memory.

Since the local memory has a lower latency and the pool memory typically has a larger storage capacity and a relatively high latency compared to the local memory, when the unused memory of the second virtual machine is determined to be overestimated while running and the second virtual machine is sensitive to latency, the latency of the memory of the second virtual machine may be reduced by reallocating the unused memory of the second virtual machine into the local memory to satisfy the customer's latency requirements or conditions.

FIG. 6 illustrates a flowchart of a memory management method according to example embodiments of the present disclosure.

Referring to FIG. 6, in operation S610, core performance measurement unit (PMU) metrics for at least one first virtual machine and core performance measurement unit metrics for a second virtual machine may be obtained.

In one or more examples, the core performance measurement unit metrics for the virtual machine may include at least one of a latency required or specified for the virtual machine, a bandwidth required or specified for the virtual machine, memory bound information about the virtual machine, and core bound information about the virtual machine. However, the above examples are exemplary and the core performance measurement unit metrics for the virtual machine are not limited thereto.

In operation S620, N virtual machines in the at least one first virtual machine that are most similar to the second virtual machine in terms of latency-related information may be determined by comparing the core performance measurement unit metrics of the at least one first virtual machine with the core performance measurement unit metrics of the second virtual machine, in which N is a positive integer.

In one or more examples, a similarity measure based on Euclidean distance may be used to determine the N virtual machines in the at least one first virtual machine that are most similar to the second virtual machine in terms of latency-related information. However, the above examples are exemplary and the similarity measurement method metrics are not limited to the Euclidean distance-based similarity measurement method and may be any other similarity measurement method.

In operation S630, whether the second virtual machine is sensitive to latency may be determined based on a proportion of the virtual machines having a latency-sensitive label among the N virtual machines.

In one or more examples, a weighted vote may be performed on the sensitivity labels of the N most similar virtual machines. When for the N most similar virtual machines in history, the majority of the votes are sensitive to the latency, the second virtual machine is determined to be sensitive to the latency. When for the N most similar virtual machines in history, the majority of the votes are not sensitive to latency, the second virtual machine is determined to be insensitive to latency.

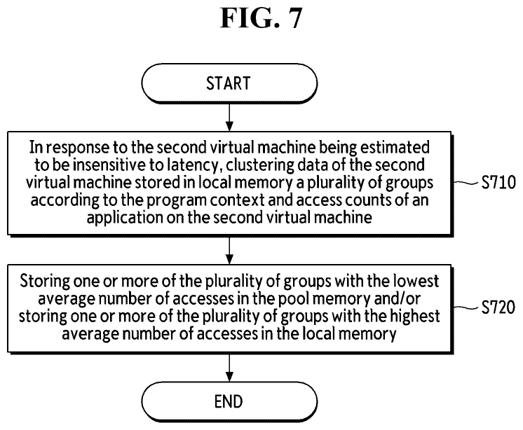

FIG. 7 illustrates a flowchart of a memory management method according to example embodiments of the present disclosure.

Referring to FIG. 7, in operation S710, in response to the second virtual machine being estimated to be insensitive to latency, data of the second virtual machine stored in local memory is clustered into a plurality of groups according to the program context and access counts of an application on the second virtual machine.

Data with similar access counts and program contexts tend to have similar access patterns. In one or more examples, access counts may reflect the frequency of past accesses. For examples, access counts may refer to a number of memory accesses within a predetermined time interval. The program context represents a program stage, and the same stage is likely to be executed repeatedly. Therefore, it may be used to estimate future data access pattern of a program.

In one or more examples, the data may be represented by a two-dimensional vector formed by the program context and the access counts. The data is then clustered into the plurality of groups using statistical methods or clustering methods such as K-means.

The program context is the sum of the program counter values along the execution path of a write associated function call. Program context may be calculated by: scanning the stack to find the return address of each function call; and aggregating these return addresses.

In operation S720, one or more of the plurality of groups with the lowest average number of accesses may be stored in the pool memory and/or one or more of the plurality of groups with the highest average number of accesses may be stored in the local memory.

The memory management method according to an example embodiment of the present disclosure illustrated in FIG. 7 may also be referred to herein as a group-based data exchange policy. In the group-based data exchange strategy, data with similar access patterns are aggregated into the same group, and groups of data with fewer accesses are moved to the pool memory, thereby reducing the frequency of accesses to pool memory. In one or more examples, in the group-based data exchange strategy, data with similar access patterns are aggregated into the same group and groups of data with a high number of accesses are moved to the local memory, thereby reducing the latency of accessing the memory.

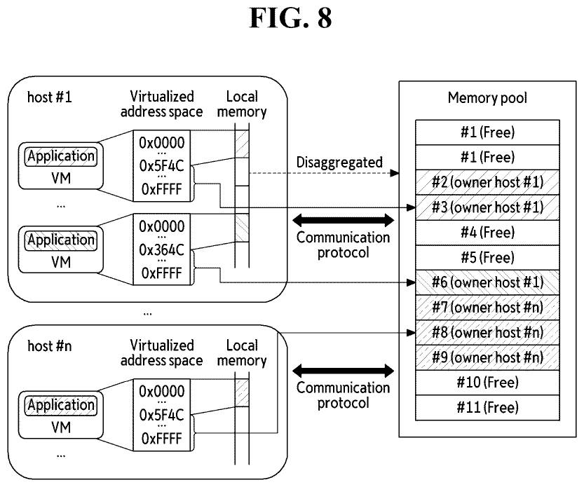

FIG. 8 illustrates a schematic diagram of a virtual machine server according to example embodiments of the present disclosure.

Referring to FIG. 8, the virtual machine server may include a plurality of hosts (host #1 to host #n) and a memory pool (e.g., a CXL memory pool). Each of the plurality of hosts may include an application and local memory (e.g., local DRAM) and communicate with the memory pool via a communication protocol (e.g., as an example only, CXL. mem). The application may create virtual machines (VMs). In one or more examples, by an application on host #1, a VM for the application on the host #1 may be allocated a predetermined range of virtual address space. In accordance with example embodiments of the present disclosure, a portion of the allocated virtual address space may be allocated into correspond to the local memory, and another portion of the allocated virtual address space may be allocated (e.g., disaggregated) to correspond to corresponding pool memory in the memory pool.

In a virtual machine server according to example embodiments of the present disclosure, since the CXL may provide a shared memory pool as a secondary memory for the VM, the shared memory pool may be dynamically reallocated into different hosts. Therefore, the plurality of hosts share pool memory, which breaks the fixed hardware configuration of hosts, and reduces memory idleness. Furthermore, in the virtual machine server according to example embodiments of the present disclosure, since the pool memory (e.g., DRAM) is rarely, if ever, accessed, the DRAM configured per server may be reduced and unused memory (UM) may be disaggregated into the shared memory pool with minimal performance loss.

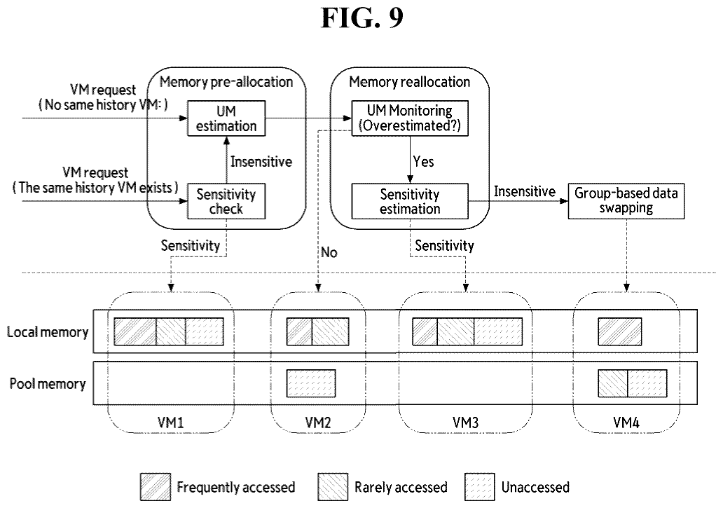

FIG. 9 illustrates a schematic diagram of a memory management method according to example embodiments of the present disclosure.

Referring to FIG. 9, the memory management method according to example embodiments of the present disclosure may include memory pre-allocation, memory reallocation, and group-based data exchange.

Memory pre-allocation may primarily include unused memory (UM) estimation and a sensitivity check (e.g., latency sensitivity check) for a new virtual machine (e.g., a second virtual machine).

When a virtual machine (VM) request is received, the unused memory estimation for the new virtual machine may be performed if a same reference virtual machine (e.g., a first virtual machine) as the new virtual machine does not exist. After performing the unused memory estimation for the new virtual machine, the estimated unused memory for the new virtual machine may be pre-allocated into a pool memory.

When a virtual machine request is received, a sensitivity check for the new virtual machine may be performed if the same reference virtual machine as the new virtual machine exists. When the sensitivity check for the new virtual machine indicates that the new virtual machine is not sensitive to latency, a further estimation of unused memory for the new virtual machine may be performed. When the sensitivity check for the new virtual machine indicates that the new virtual machine is sensitive to the latency, all the memory of the new virtual machine may be pre-allocated into the local memory. In one or more examples, it is assumed that the memory of the new virtual machine includes frequently used memory, infrequently used memory, and unused memory. The frequently used memory may be space for storing hot data, the infrequently used memory may be space for storing cold data, and the unused memory may be space that is never accessed. In one or more examples, hot data may refer to data that requires a number of accesses that exceed a threshold over a period of time, and cold data may refer to data that requires a number of accesses that is equal to or less than a threshold over a period of time. However, the present disclosure is not limited thereto, and the memory of a new virtual machine may also include only one or more of frequently used memory, infrequently used memory, and unused memory. For example, referring to FIG. 9, when a sensitivity check of the virtual machine VM1 indicates that the virtual machine VM1 is sensitive to latency, the frequently used memory, the infrequently used memory, and the unused memory of the memory of the virtual machine VM1 may be allocated into the local memory. VM1 may be initially latency sensitive.

In one or more examples, memory reallocation may include unused memory monitoring and sensitivity estimation. The unused memory monitoring may be used to monitor whether the unused memory is overestimated throughout the runtime of a virtual machine. Sensitivity estimation is used to predict whether an application's performance will degrade as memory latency increases and to determine whether to completely reallocate the virtual machine's memory into the local memory.

When the unused memory monitoring indicates that the unused memory is not overestimated, the unused memory monitoring may continue to be performed. For example, referring to FIG. 9, when the virtual machine VM2 is determined to be insensitive to latency in memory pre-allocation and the unused memory of the virtual machine VM2 is determined to be not overestimated in memory reallocation, the frequently used memory and the infrequently used memory of the virtual machine VM2 may be allocated into the local memory and the unused memory of the virtual machine VM2 may be allocated into the pool memory. The VM2 may be latency insensitive with unused memory not being overestimated.

When the unused memory monitoring indicates that the unused memory is overestimated, sensitivity estimation may be performed. For example, latency-sensitive virtual machines may be identified using a similarity-based approach. When the sensitivity estimation indicates that the new virtual machine is sensitive to the latency, all memory of the new virtual machine may be reallocated into the local memory to avoid performance degradation. For example, referring to FIG. 9, when the sensitivity estimation for the virtual machine VM3 indicates that the virtual machine VM3 is sensitive to the latency at runtime (e.g., runtime sensitive), frequently used memory, infrequently used memory, and unused memory of the virtual machine VM3 may be allocated into the local memory.

When the sensitivity estimation indicates that the new virtual machine is not sensitive to latency, group-based data exchange may be performed. In the group-based data exchange, cold data of the virtual machine that is latency-insensitive is exchanged into the pool memory, thereby reducing the frequency of accesses to the pool memory. For example, referring to FIG. 9, when the unused memory of a virtual machine VM4 is determined not to be overestimated in the memory reallocation and the sensitivity estimation of the virtual machine VM4 indicates that the virtual machine VM4 is latency-insensitive at runtime, the frequently used memory of the virtual machine VM4 may be allocated into local memory, and the infrequently used memory and the unused memory of the virtual machine VM4 may be allocated into the pool memory. The VM4 may be latency insensitive with overestimated unused memory.

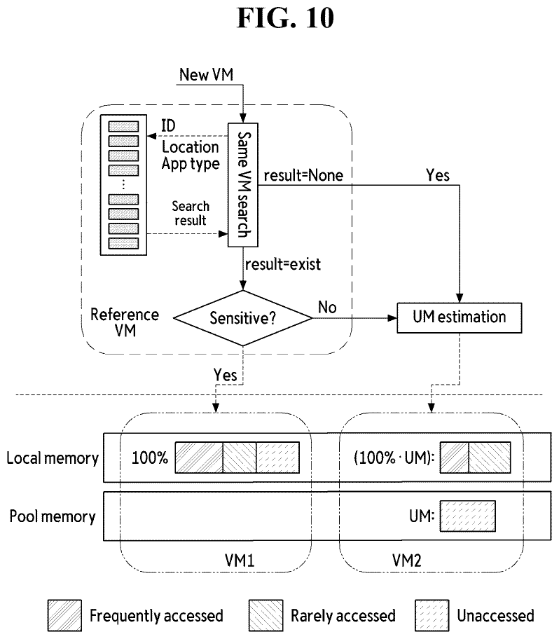

FIG. 10 illustrates a schematic diagram of memory pre-allocation according to example embodiments of the present disclosure.

Referring to FIG. 10, memory resources may be pre-allocated for a virtual machine according to an initial sensitivity check result and an unused memory estimation value UM (e.g., a percentage value).

In response to a request from a new VM, a same VM search may be performed. The same VM search may be performed by comparing the memory usage information (e.g., by way of example only, the same customer ID, application type, and location (the location of the customer, e.g., a city and a region)) of the new virtual machine with the memory usage information of the reference VMs and the search results are returned.

If the search results indicate that there are same reference virtual machines with the same memory usage information as the new virtual machine, whether the new virtual machine is sensitive to the latency may be determined. When the search results indicate that there are same history VMs with the same memory usage information as the new virtual machine and that the same reference virtual machines are sensitive to the latency, the memory (e.g., frequently-used memory, infrequently-used memory, and unused memory) of the new virtual machine may be completely allocated into the local memory. Referring to FIG. 10, the frequently used memory, infrequently used memory, and unused memory of the new virtual machine VM1 may be completely allocated into the local memory.

If the search results indicate that there is no same history VM with the same memory usage information as the new virtual machine, a UM estimation may be performed to estimate the UM of the new virtual machine. After estimating the UM of the new virtual machine, the memory corresponding to the UM in the memory of the new VM may be allocated into the pool memory, and the memory corresponding to the 100%-UM in the memory of the new VM may be allocated into the local memory. Referring to FIG. 10, memory corresponding to the UM (e.g., unused memory) in the memory of the new virtual machine VM2 may be allocated into the pool memory, and memory corresponding to the 100%-UM (e.g., frequently used memory and infrequently used memory) in the memory of the new virtual machine may be allocated into the local memory.

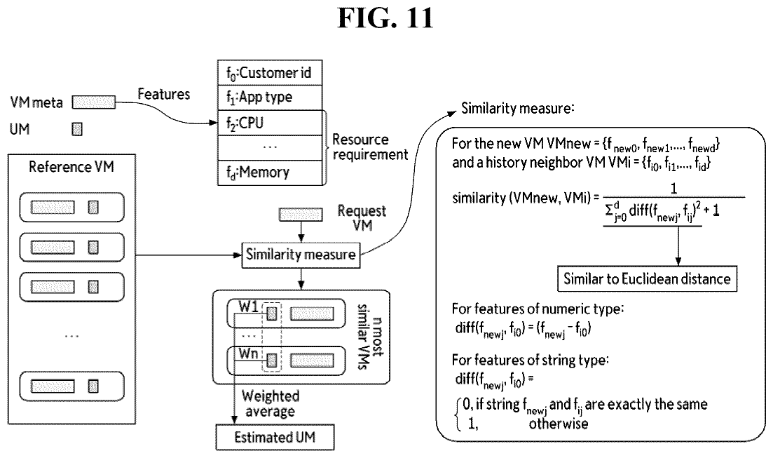

FIG. 11 illustrates a schematic diagram of a similarity-based unused memory estimation method according to example embodiments of the present disclosure.

In one or more examples, UM may be used to reflect the proportion of memory that will not be accessed by a new VM at pool memory pre-allocation. By performing a similarity measurement using the similarity-based estimation method, the n most similar VMs of the new VM may be found from the history, and the estimated UM of the new VM is a weighted average of the UM values of the n most similar VMs. In one or more examples, by finding the n most similar VMs in the history, each similar VM may be assigned a different weight (e.g., weights W1 to Wn) based on its customer ID, which may be used to more accurately estimate the UM or sensitivity of the virtual machine. If the similar VM has the same customer ID as the new VM, its weight is a first weight (e.g., 2), otherwise its weight is a second weight (e.g., 1) that is smaller than the first weight.

In one or more examples, for a history VM, its UM value may be obtained by scanning the access bits of the hypervisor page table during its lifecycle. For example, the similarity of two VMs may be the inverse of the Euclidean distance between the two VMs, as shown in FIG. 11. The calculation of the Euclidean distance may be slightly modified due to the presence of features of string type (e.g., customer ID and application type). For features of string type, feature differences are defined as 0 (string attribute values are same) and 1 (string attribute values are not same).

Even with a small amount of history VM data, the similarity-based unused memory estimation method of the example embodiments of the present disclosure may obtain good results. In addition, the performance of the similarity-based unused memory estimation method of the example embodiments of the present disclosure is less affected by changes in data distribution than conventional machine learning methods.

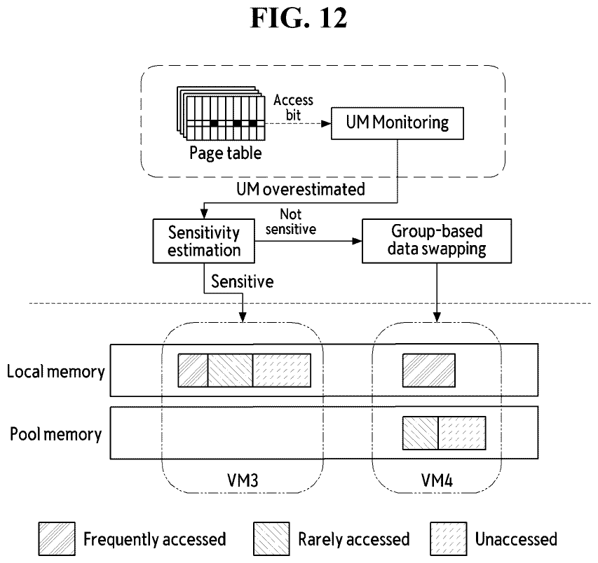

FIG. 12 illustrates a schematic diagram of memory reallocation and group-based data exchange according to example embodiments of the present disclosure.

At the whole runtime of the virtual machine, the UM monitor monitors whether UM is overestimated. In one or more examples, the UM monitor monitors whether UM is overestimated by reading relevant information (e.g., access bits) from a page table. If UM is overestimated during memory pre-allocation, the VM must store some of its data on pool DRAM. Since the access latency of the pool DRAM may affect different virtual machines differently, different strategies may be implemented as shown in FIG. 12. For example, when the UM is overestimated in memory pre-allocation process, sensitivity estimation of the virtual machine may be performed.

When the sensitivity estimation of the virtual machine indicates that the virtual machine is sensitive to latency, the memory (e.g., frequently-used memory, infrequently-used memory, and unused memory) of the virtual machine may be completely allocated into local memory. Referring to FIG. 12, the frequently used memory, the infrequently used memory, and the unused memory of a new virtual machine VM3 may be completely allocated into local memory.

Group-based data exchange may be performed when the sensitivity estimation for a virtual machine indicates that the virtual machine is not sensitive to latency. For example, referring to FIG. 12, the group-based data exchange may be performed when the sensitivity estimation for a virtual machine VM4 indicates that the virtual machine VM4 is not sensitive to latency. After performing the group-based data exchange, the frequently used memory of the virtual machine VM4 may be allocated into the local memory, and the infrequently used memory and the unused memory of the virtual machine VM4 may be allocated into pool memory.

Memory reallocation, according to example embodiments of the present disclosure, may use a similarity-based sensitivity estimation method to identify the latency-sensitive virtual machine and completely reallocate the memory of the latency-sensitive virtual machine into the local memory. Thus, for the latency-sensitive virtual machines, all of their memory is reallocated into local DRAM to avoid the impact of pool access latency on application performance.

For latency-insensitive virtual machines, the group-based data exchange policy may be performed to exchange cold data into pool memory. Therefore, for latency-insensitive virtual machines, the group-based data exchange policy is proposed to reduce the performance degradation and therefore memory reallocation is not required.

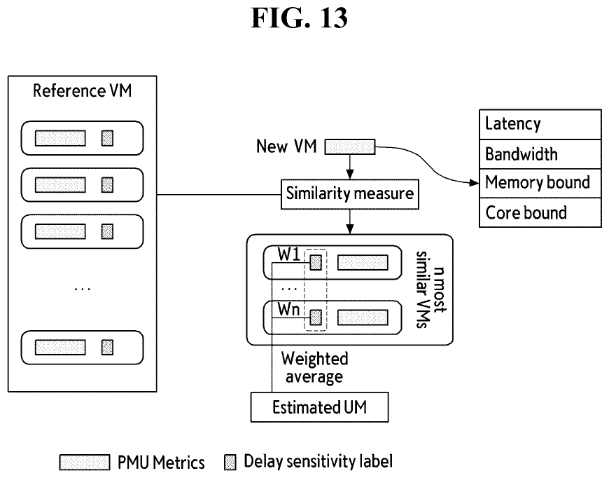

FIG. 13 illustrates a schematic diagram of estimating a sensitivity of a virtual machine according to example embodiments of the present disclosure.

In one or more examples, sensitivity estimation may be used to predict whether the performance of an application will degrade as memory latency increases, and to determine whether to completely reallocate the memory of the VM into the local DRAM. The sensitivity of the VM may be estimated in the following two operations:
1) Finding the N most similar VMs from reference data using a similarity measure based on Euclidean distance based on the core Performance Measurement Unit (PMU) metrics.
2) Weighted voting on the sensitivity labels of the N most similar virtual machines. In one or more examples, weighted voting may be performed by assigning weights (e.g., weights W1 to weights Wn) to the N most similar virtual machines. In the example of assigning the same weights to the N most similar virtual machines, the following case is estimated to be sensitive: for the N most similar virtual machines in history, the majority of the votes are sensitive to the latency. The following case is estimated to be insensitive: for the N most similar virtual machines in history, the majority of the votes are latency-insensitive.

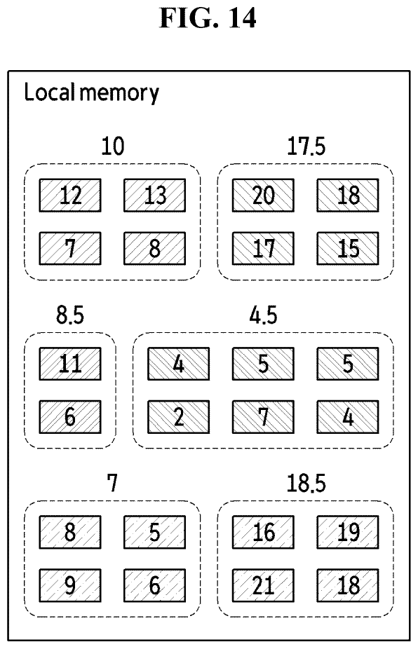

FIG. 14 illustrates a schematic diagram of group-based data exchange according to example embodiments of the present disclosure.

For VMs with latency-insensitive workloads, pool memory is used as secondary memory when their UMs are overestimated. When there is almost no free capacity in the local memory, infrequently accessed data is moved out to the secondary memory (the pool memory). As a result, latency-insensitive virtual machines access the pool memory less frequently.

For some applications running on a virtual machine, there are multiple data access patterns. Based on the analysis, data units (e.g., pages or address segments) with similar program contexts and access counts are considered to have similar access patterns. The main operations are as follows: the data are clustered into groups based on the program context and the access counts. The group with the lowest average access count (e.g., the group with an average access count of 4.5 illustrated in FIG. 14) is moved out to the pool memory.

As understood by one of ordinary skill in the art, data with similar access counts and program contexts tend to have similar access patterns. Access counts may reflect the frequency of past accesses. Program context represents a program stage, and the same stage is likely to be executed repeatedly. Therefore, it may be used to estimate the future data access pattern of a program.

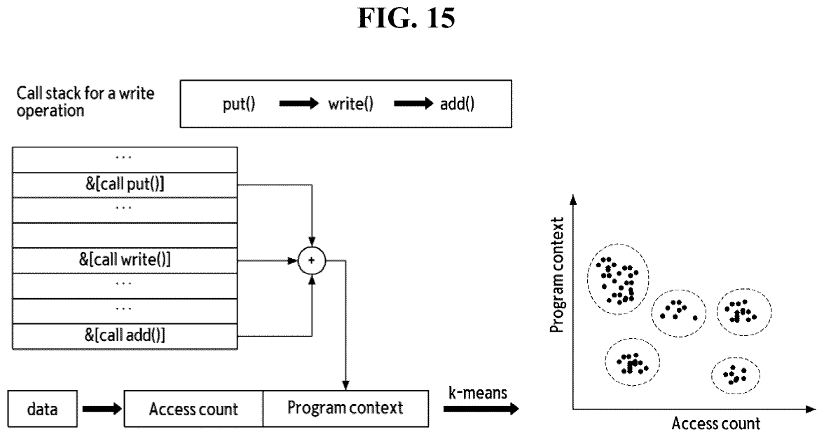

FIG. 15 illustrates a schematic diagram of clustering data into groups according to example embodiments of the present disclosure.

Referring to FIG. 15, the data may be represented by a two-dimensional vector formed by the program context and the access counts. The data is then clustered into the plurality of groups using statistical methods or clustering methods such as K-means. In one or more examples, K-means may be implemented as an unsupervised learning algorithm, where clustering is performed between objects that share similarities.

The program context is the sum of the program counter values along the execution path of a write associated function call. The value may be calculated by: scanning the stack to find the return address of each function call; and aggregating these return addresses.

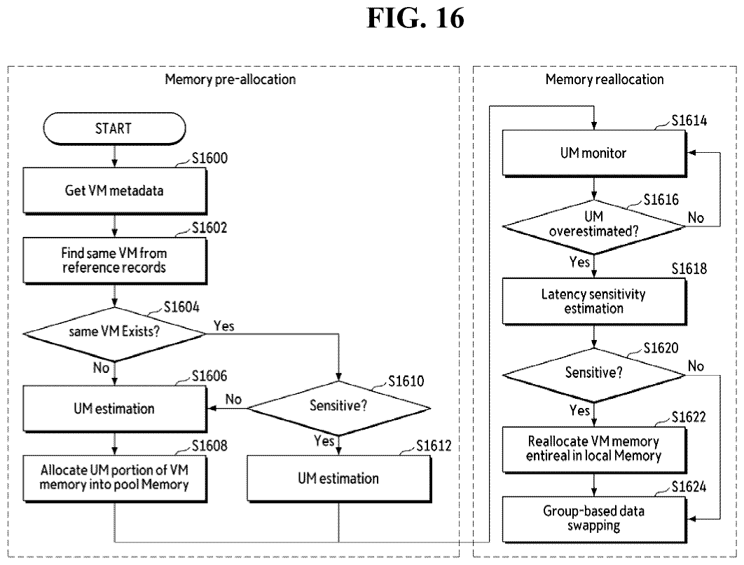

FIG. 16 illustrates a flowchart of memory pre-allocation and memory reallocation according to example embodiments of the present disclosure.

Referring to FIG. 16, in the memory pre-allocation, VM metadata for a new virtual machine is obtained (S1600). For the new virtual machine, the same virtual machine with the same customer ID, application type, and location is first searched from the reference records (S1602). If the same VM exists (S1602), whether the same VM is sensitive (S1610) to the latency is checked. If it is sensitive to the latency, the memory of the VM is completely allocated (S1612) into the local DRAM. For a new VM, if there is no same VM in the history or the same VM is not sensitive to latency, the proposed similarity-based approach is used to predict the UM value (S1606). The UM portion of the VM memory is allocated into the DRAM pool (S1608).

In memory reallocation, page table monitor is used to monitor the UM (S1614) of all the virtual machines. If the UM of the virtual machine is overestimated (S1616), the proposed similarity based approach is used to predict whether the workload of the virtual machine is sensitive to latency (S1618). If the workload of the virtual machine is sensitive to the latency (S1620), its memory is completely reallocated (S1622) into the local DRAM. Otherwise, the group-based data exchange policy is performed (S1624) to ensure that the cold data is stored on the pool memory.

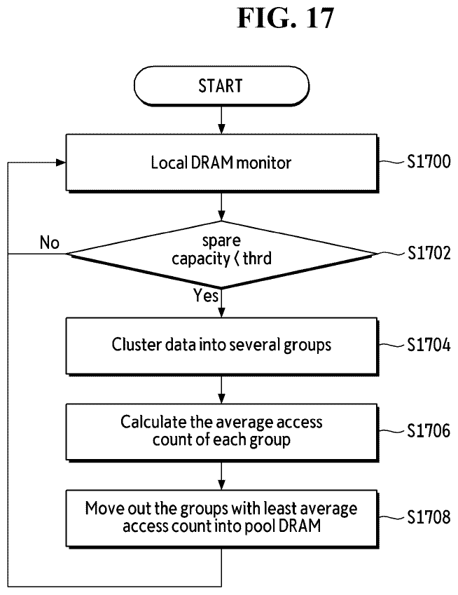

FIG. 17 illustrates a flowchart of a group-based data exchange according to an example embodiment of the present disclosure.

Referring to FIG. 17, local memory usage may be monitored (S1700) by a local memory monitor by scanning access bits of a page table. If the free space in the local memory is less than a specific threshold (S1702), the cold data is moved into the pool memory using the proposed group-based data exchange policy (i.e., the data in the local memory is clustered (S1704) into a plurality of groups according to the access counts and the program context). By calculating the average access counts of each group (S1706), the data group with the lowest average access count is moved into the pool DRAM (S1708). Otherwise, the local memory usage information is continuously monitored.

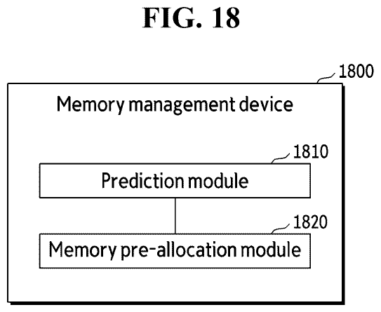

FIG. 18 illustrates a block diagram of a memory management device according to example embodiments of the present disclosure.

Referring to FIG. 18, a memory management device 1800 according to example embodiments of the present disclosure may include a prediction module 1810 and a memory pre-allocation module 1820.

The prediction module 1810 may predict unused memory value and/or the latency sensitivity of a second virtual machine for which the memory is to be allocated based on unused memory value and/or the latency sensitivity of at least one first virtual machine for which the memory has been allocated.

The memory pre-allocation module 1820 may pre-allocate the memory to be allocated for the second virtual machine based on the predicted unused memory value and/or latency sensitivity of the second virtual machine.

In other words, the prediction module 1810 performs a data prediction operation (e.g., an operation to predict or estimate the unused memory value and/or the latency sensitivity) and the memory pre-allocation module 1820 performs a memory pre-allocation operation. Since the data prediction operation and the memory pre-allocation operation have been specifically described above with reference to one or more of FIGS. 1 to 17, the same description will not be repeated herein.

In addition, optionally, the memory management device 1800 may further include a memory reallocation module. The memory reallocation module may determine whether the unused memory in the allocated memory of the second virtual machine is overestimated by comparing the actual unused memory of the second virtual machine that is monitored while the second virtual machine runs to the unused memory in the allocated memory of the second virtual machine; in response to determining that the unused memory in the allocated memory of the second virtual machine is overestimated, estimate whether the second virtual machine is sensitive to latency; and in response to the second virtual machine being estimated to be sensitive to latency; reallocating the unused memory of the second virtual machine into local memory. In other words, the memory reallocation module may perform a memory reallocation operation. Since the memory reallocation operation has been specifically described above with reference to one or more of FIGS. 1 to 17, the same description will not be repeated herein.

In addition, optionally, the memory management device 1800 may include a data exchange module (not shown). The data exchange module may, in response to the second virtual machine being estimated to be latency-insensitive; cluster the data of the second virtual machine stored in local memory into a plurality of groups based on the program context and the access count of an application on the second virtual machine; store one or more of the plurality of groups with the lowest average access count in the pool memory and/or store one or more of the plurality of groups with the highest average access count in the local memory. In other words, the memory reallocation module may perform group-based data exchange operations. Since the group-based data exchange operation has been specifically described above with reference to one or more of FIGS. 1 to 17, the same description will not be repeated herein.

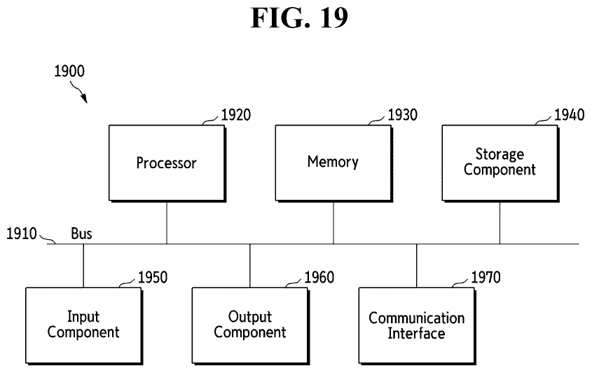

FIG. 19 is a block diagram of example components of one or more devices of FIG. 1. The device 1900 may correspond to the user device 110 and/or the platform 1160. The device 1900 may be any other suitable device such as a TV, wall panel, etc. As shown in FIG. 19, the device 1900 may include a bus 1910, a processor 1920, a memory 1930, a storage component 1940, an input component 1950, an output component 1960, and a communication interface 1970.

The bus 1910 includes a component that permits communication among the components of the device 1900. The processor 1920 is implemented in hardware, firmware, or a combination of hardware and software. The processor 1920 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 1920 includes one or more processors capable of being programmed to perform a function. The memory 1930 includes a random access memory (RAM), a read only memory (ROM), and/or another type of dynamic or static storage device (e.g. a flash memory, a magnetic memory, and/or an optical memory) that stores information and/or instructions for use by the processor 1920.

The storage component 1940 stores information and/or software related to the operation and use of the device 1900. For example, the storage component 1940 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 1950 includes a component that permits the device 1900 to receive information, such as via user input (e.g. a touch screen display, a keyboard, a keypad, a mouse, a button, a switch, and/or a microphone). Additionally, or alternatively, the input component 1950 may include a sensor for sensing information (e.g. a global positioning system (GPS) component, an accelerometer, a gyroscope, and/or an actuator). The output component 1960 includes a component that provides output information from the device 1900 (e.g. a display, a speaker, and/or one or more light-emitting diodes (LEDs)).

The communication interface 1970 includes a transceiver-like component (e.g., a transceiver and/or a separate receiver and transmitter) that enables the device 1900 to communicate with other devices, such as via a wired connection, a wireless connection, or a combination of wired and wireless connections. The communication interface 1970 may permit the device 1900 to receive information from another device and/or provide information to another device. For example, the communication interface 1970 may include an Ethernet interface, an optical interface, a coaxial interface, an infrared interface, a radio frequency (RF) interface, a universal serial bus (USB) interface, a Wi-Fi interface, a cellular network interface, or the like.

The device 1900 may perform one or more processes described herein. The device 1900 may perform these processes in response to the processor 1920 executing software instructions stored by a non-transitory computer-readable medium, such as the memory 1930 and/or the storage component 1940. A computer-readable medium is defined herein as a non-transitory memory device. A memory device includes memory space within a single physical storage device or memory space spread across multiple physical storage devices.

Software instructions may be read into the memory 1930 and/or the storage component 1940 from another computer-readable medium or from another device via the communication interface 1970. When executed, software instructions stored in the memory 1930 and/or the storage component 1940 may cause the processor 1920 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 19 are provided as an example. In practice, the device 1900 may include additional components, fewer components, different components, or differently arranged components than those shown in FIG. 19. Additionally, or alternatively, a set of components (e.g. one or more components) of the device 1900 may perform one or more functions described as being performed by another set of components of the device 1900.

According to the memory management method example embodiments of the present disclosure, since the unused memory value and/or the latency sensitivity of the at least one first virtual machine for which memory has been allocated is used as a basis for predicting the unused memory value and/or the latency sensitivity of the second virtual machine for which the memory is to be allocated, the unused memory value and/or the latency sensitivity of the second virtual machine for which the memory is to be allocated may be accurately predicted.

According to the memory management method of example embodiments of the present disclosure, since the unused memory value and/or the latency sensitivity of the second virtual machine for which the memory is to be allocated may be predicted based on the unused memory values and/or the latency sensitivities of the n virtual machines that are most similar to the second virtual machine in terms of the memory usage information, it is possible to more accurately predict the unused memory value and/or the latency sensitivity of the second virtual machine for which the memory is to be allocated.

According to the memory management method of example embodiments of the present disclosure, compared to the prior art where the entire memory address space corresponding to the maximum amount of the memory of the virtual machine must be pre-allocated statically, it is more reasonable to pre-allocate the memory of the second virtual machine based on the accurately predicted unused memory value and/or the latency sensitivity of the second virtual machine for which the memory is to be allocated, which reduces the possibility of the memory being left unused.

According to the memory management method of example embodiments of the present disclosure, even with a small amount of reference virtual machine data, similarity-based prediction of unused memory value and/or the latency sensitivity of the second virtual machine for which memory is to be allocated can yield good results. In addition, the performance of the similarity-based method of predicting the unused memory value and/or the latency sensitivity of the second virtual machine for which memory is to be allocated is less affected by changes in the data distribution compared to conventional machine learning methods.

According to the memory management method of example embodiments of the present disclosure, the latency sensitivity of the second virtual machine may be accurately predicted based on latency sensitivities of one or more first virtual machines that are the same as the second virtual machine in terms of memory usage information.

According to the memory management method of example embodiments of the present disclosure, the latency of the memory of the second virtual machine may be minimized by pre-allocating the memory to be allocated for the second virtual machine that is sensitive to the latency into the local memory.

According to the memory management method of example embodiments of the present disclosure, by pre-allocating the memory corresponding to the predicted unused memory value of the second virtual machine in the memory to be allocated for the second virtual machine into the pool memory, the storage space of the local memory may be saved, and at the same time, there is less of a problem of idling of the local memory.

According to the memory management method of example embodiments of the present disclosure, since the access latency of the pool memory may have different influences on different virtual machines, the memory allocation operation may be performed further considering the latency of the virtual machine to meet the latency requirements or conditions of the virtual machine.

According to the memory management method of example embodiments of the present disclosure, when the unused memory of the second virtual machine is determined to be overestimated while running and the second virtual machine is sensitive to latency, the latency of the memory of the second virtual machine may be reduced by reallocating the unused memory of the second virtual machine into the local memory to satisfy the customer's latency requirements or conditions.

According to the memory management method of example embodiments of the present disclosure, in the group-based data exchange strategy, data with similar access patterns are aggregated into the same group, and groups of data with fewer accesses are moved to the pool memory, thereby reducing the frequency of accesses to pool memory. Optionally, in the group-based data exchange strategy, data with similar access patterns are aggregated into the same group and groups of data with a high number of accesses are moved to the local memory, thereby reducing the latency of accessing the memory.

According to the memory management method of example embodiments of the present disclosure, since the pool memory (e.g., DRAM) is rarely, if ever, accessed, the DRAM configured per server may be reduced and unused memory (UM) may be disaggregated into the shared memory pool with minimal performance loss.

According to the memory management method of example embodiments of the present disclosure, the similarity-based method is less affected by changes in data distribution, it performs well even if the number of reference virtual machines is small, and accurate results are obtained by assigning different weights to similar virtual machines based on customer IDs. As a result, used and unused memory of virtual machines may be allocated more rationally by accurately estimating UM and latency sensitivity.

According to the memory management method of example embodiments of the present disclosure, a group-based data exchange strategy is proposed to reduce the frequency of accesses to the pool memory by aggregating data with similar access patterns into the same group and moving the group of data with fewer access counts to the pool memory.

According to the memory management method of example embodiments of the present disclosure, the memory stranding problem is solved using a CXL memory pool that may be accessed with nanosecond latency.

According to the memory management method of example embodiments of the present disclosure, pool memory accesses for latency-sensitive applications may be avoided and pool memory accesses for latency-insensitive applications may be reduced through accurate memory allocation and management.

CXL memory is virtualized using hypervisor page tables and memory management units and may therefore be pre-allocated statically into virtual machines. Thus memory management methods according to example embodiments of the present disclosure are compatible with virtualization accelerators.

According to one or more example embodiments, the above-described processor may be implemented using a combination of hardware, hardware, and software, or a non-transitory storage medium storing executable software for performing its functions.

Hardware may be implemented using processing circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUs), one or more microprocessors, one or more Application Specific Integrated Circuits (ASICs), or any other device or devices capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, etc., capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., one or more processors, CPUs, controllers, ALUs, DSPs, microcomputers, microprocessors, etc.), the computer processing device may be configured to carry out program code by performing arithmetical, logical, and input/output operations, according to the program code. Once the program code is loaded into a computer processing device, the computer processing device may be programed to perform the program code, thereby transforming the computer processing device into a special purpose computer processing device. In a more specific example, when the program code is loaded into a processor, the processor becomes programed to perform the program code and operations corresponding thereto, thereby transforming the processor into a special purpose processor. In another example, the hardware device may be an integrated circuit customized into special purpose processing circuitry (e.g., an ASIC).

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Software and/or data may be embodied permanently or temporarily in any type of storage media including, but not limited to, any machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including tangible or non-transitory computer-readable storage media as discussed herein.

Storage media may also include one or more storage devices at units and/or devices according to one or more example embodiments. The one or more storage devices may be tangible or non-transitory computer-readable storage media, such as random access memory (RAM), read only memory (ROM), a permanent mass storage device (such as a disk drive), and/or any other similar data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other similar computer readable storage media. The computer programs, program code, instructions, or some combination thereof, may be loaded into the one or more storage devices and/or the one or more computer processing devices from a remote data storage device via a network interface, rather than via a computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other suitable medium known to one of ordinary skill in the art.

The one or more hardware devices, the storage media, the computer programs, program code, instructions, or some combination thereof, may be specially designed and constructed for the purposes of the example embodiments, or they may be known devices that are altered and/or modified for the purposes of example embodiments.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of example embodiments of the present inventive concepts. Accordingly, all such modifications are intended to be included within the scope of example embodiments of the present inventive concepts as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A memory management method comprising:
predicting, based on an unused memory value and/or a latency sensitivity of at least one first virtual machine for which a memory has been allocated, an unused memory value and/or a latency sensitivity of a second virtual machine for which memory is to be allocated, wherein the latency sensitivity of a respective virtual machine indicates whether the respective virtual machine is sensitive to a latency based on whether a latency condition indicating that the respective virtual machine is sensitive to latency is satisfied; and
pre-allocating the memory to be allocated for the second virtual machine based on the predicted unused memory value and/or latency sensitivity of the second virtual machine.

2. The memory management method according to claim 1, wherein the predicting the unused memory value and/or the latency sensitivity of the second virtual machine for which the memory is to be allocated further comprises:
determining at least one similarity between (i) memory usage information of the at least one first virtual machine and (ii) memory usage information of the second virtual machine, wherein memory usage information of the respective virtual machine includes one or more of (a) an identity of a customer corresponding to the respective virtual machine, (b) a type of application corresponding to the respective virtual machine, (c) a location of the customer, (d) information of a processor specified by the respective virtual machine, and (e) information of a memory specified by the respective virtual machine; and
predicting the unused memory value and/or the latency sensitivity of the second virtual machine based on the at least one similarity and the unused memory value and/or the latency sensitivity of the at least one first virtual machine.

3. The memory management method according to claim 2, wherein the at least one first virtual machine comprises n first virtual machines, wherein n is a positive integer,
wherein the predicting the unused memory value of the second virtual machine further comprises:
allocating n weights respectively to n unused memory values of the n first virtual machines based on n similarities between n memory usage information of the n first virtual machines, respectively, and the memory usage information of the second virtual machine; and
predicting an unused memory estimation value for the second virtual machine by performing a weighted average calculation based on the n unused memory values of the n first virtual machines and the n weights corresponding to the n unused memory values.

4. The memory management method according to claim 2, wherein the predicting the latency sensitivity of the second virtual machine comprises:
determining whether one or more first virtual machines of the at least one first virtual machine are sensitive to the latency in response to the similarity indicating that the memory usage information of the second virtual machine is the same as memory usage information of the one or more first virtual machines;
predicting the latency sensitivity of the second virtual machine to be sensitive to latency in response to a number of first virtual machines in the one or more first virtual machines that are sensitive to the latency being greater than or equal to half of the number of the one or more first virtual machines; and
predicting the latency sensitivity of the second virtual machine to be insensitive to latency in response to the number of first virtual machines in the one or more first virtual machines that are sensitive to the latency being smaller than the half of the number of the one or more first virtual machines.

5. The memory management method according to claim 1, wherein the pre-allocating the memory to be allocated for the second virtual machine further comprises:
pre-allocating, in response to the latency sensitivity in the unused memory value and the predicted latency sensitivity of the second virtual machine indicating that the second virtual machine is sensitive to the latency, the memory to be allocated for the second virtual machine into local memory;
pre-allocating, in response to the unused memory value indicating the second virtual machine is sensitive to latency, predicted unused memory corresponding to the predicted unused memory value of the second virtual machine in the memory to be allocated for the second virtual machine into a pool memory and pre-allocating remaining memory in the memory to be allocated for the second virtual machine, other than the predicted unused memory, into the local memory; and/or
pre-allocating, in response to both the unused memory value and the predicted latency sensitivity of the second virtual machine indicating that the second virtual machine is insensitive to the latency, the predicted unused memory in the memory to be allocated for the second virtual machine into the pool memory and pre-allocating remaining memory in the memory to be allocated for the second virtual machine, other than the predicted unused memory, into the local memory.

6. The memory management method according to claim 1, wherein the memory management method further comprises:
determining whether the unused memory in the allocated memory of the second virtual machine is overestimated by comparing an actual unused memory of the second virtual machine, which is monitored while the second virtual machine runs, with the unused memory in the allocated memory of the second virtual machine;
estimating whether the second virtual machine is sensitive to the latency in response to determining that the unused memory in the allocated memory of the second virtual machine is overestimated; and
reallocating the used memory of the second virtual machine into local memory in response to the second virtual machine being estimated to be sensitive to latency.

7. The memory management method according to claim 6, wherein estimating whether the second virtual machine is sensitive to the latency comprises:
obtaining core performance measurement unit metrics for the at least one first virtual machine and core performance measurement unit metrics for the second virtual machine;
determining N virtual machines in the at least one first virtual machine that are most similar to the second virtual machine in terms of latency-related information by comparing the core performance measurement unit metrics of the at least one first virtual machine with the core performance measurement unit metrics of the second virtual machine, wherein n is a positive integer; and
determining whether the second virtual machine is sensitive to latency based on determining that a number of the virtual machines having a sensitive to a latency label among the N virtual machines is greater than or equal to a threshold.

8. The memory management method according to claim 6, wherein the memory management method further comprises:
clustering, in response to the second virtual machine being estimated to be insensitive to latency, data of the second virtual machine stored in local memory a plurality of groups according to a program context and one or more access counts of an application on the second virtual machine; and
storing one or more of the plurality of groups with a lowest average number of accesses in a pool memory and/or storing one or more of the plurality of groups with a highest average number of accesses in the local memory.

9. The memory management method according to claim 1, wherein the at least one first virtual machine is n virtual machines, among a plurality of first virtual machines for which a memory has been allocated, having memory usage information that is most similar to the memory usage information of the second virtual machine, wherein n is a positive integer, and
wherein the memory usage information of the virtual machine includes one or more of an identity of a customer corresponding to the virtual machine, a type of application corresponding to the virtual machine, a location of the customer, information of a processor specified by the virtual machine, and information of memory specified by the virtual machine.

10. A memory management device, comprising:
a memory storing one or more instructions; and
a processor operatively coupled to the memory and configured to execute the one or more instructions,
wherein, when the processor executes the one or more instructions, the memory management device is configured to:
predict, based on an unused memory value and/or a latency sensitivity of at least one first virtual machine for which a memory has been allocated, an unused memory value and/or a latency sensitivity of a second virtual machine for which memory is to be allocated, wherein the latency sensitivity of a respective virtual machine indicates whether the respective virtual machine is sensitive to a latency based on whether a latency condition indicating that the respective virtual machine is sensitive to latency is satisfied; and
pre-allocate the memory to be allocated for the second virtual machine based on the predicted unused memory value and/or latency sensitivity of the second virtual machine.

11. The memory management device according to claim 10, wherein the one or more instructions, when executed by the processor to predict the unused memory value and/or the latency sensitivity of the second virtual machine for which the memory is to be allocated, further cause the memory management device to:
determine at least one similarity between (i) memory usage information of the at least one first virtual machine and (ii) memory usage information of the second virtual machine, wherein memory usage information of the respective virtual machine includes one or more of (a) an identity of a customer corresponding to the respective virtual machine, (b) a type of application corresponding to the respective virtual machine, (c) a location of the customer, (d) information of a processor specified by the respective virtual machine, and (e) information of a memory specified by the respective virtual machine, and
predict the unused memory value and/or the latency sensitivity of the second virtual machine based on the at least one similarity and the unused memory value and/or the latency sensitivity of the at least one first virtual machine.

12. The memory management device according to claim 11, wherein the at least one first virtual machine comprises n first virtual machines, wherein n is a positive integer,
wherein the one or more instructions, when executed by the processor to predict the unused memory value of the second virtual machine, further cause the memory management device to:
allocate n weights respectively to n unused memory values of the n first virtual machines based on n similarities between n memory usage information of the n first virtual machines, respectively, and the memory usage information of the second virtual machine, and
predict an unused memory estimation value for the second virtual machine by performing a weighted average calculation based on the n unused memory values of the n first virtual machines and the n weights corresponding to the n unused memory values.

13. The memory management device according to claim 11, wherein the one or more instructions, when executed by the processor to predict the latency sensitivity of the second virtual machine, further cause the memory management device to:
determine whether one or more first virtual machines of the at least one first virtual machine are sensitive to the latency in response to the similarity indicating that the memory usage information of the second virtual machine is the same as memory usage information of the one or more first virtual machines,
predict the latency sensitivity of the second virtual machine to be sensitive to latency in response to a number of first virtual machines in the one or more first virtual machines that are sensitive to the latency being greater than or equal to half of the number of the one or more first virtual machines, and
predict the latency sensitivity of the second virtual machine to be insensitive to latency in response to the number of first virtual machines in the one or more first virtual machines that are sensitive to the latency being smaller than the half of the number of the one or more first virtual machines.

14. The memory management device according to claim 10, wherein the one or more instructions, when executed by the processor to pre-allocate the memory to be allocated for the second virtual machine, further cause the memory management device to:
pre-allocate, in response to the latency sensitivity in the unused memory value and the predicted latency sensitivity of the second virtual machine indicating that the second virtual machine is sensitive to the latency, the memory to be allocated for the second virtual machine into local memory;
pre-allocate, in response to the unused memory value indicating the second virtual machine is sensitive to latency, predicted unused memory corresponding to the predicted unused memory value of the second virtual machine in the memory to be allocated for the second virtual machine into a pool memory and pre-allocating remaining memory in the memory to be allocated for the second virtual machine, other than the predicted unused memory, into the local memory, and/or
pre-allocate, in response to both the unused memory value and the predicted latency sensitivity of the second virtual machine indicating that the second virtual machine is insensitive to the latency, the predicted unused memory in the memory to be allocated for the second virtual machine into the pool memory and pre-allocating remaining memory in the memory to be allocated for the second virtual machine, other than the predicted unused memory, into the local memory.

15. The memory management device according to claim 10, wherein the one or more instructions, when executed by the processor, further cause the memory management device to:
determine whether the unused memory in the allocated memory of the second virtual machine is overestimated by comparing an actual unused memory of the second virtual machine, which is monitored while the second virtual machine runs, with the unused memory in the allocated memory of the second virtual machine,
estimate whether the second virtual machine is sensitive to the latency in response to determining that the unused memory in the allocated memory of the second virtual machine is overestimated, and
reallocate the used memory of the second virtual machine into the local memory in response to the second virtual machine being estimated to be sensitive to latency.

16. The memory management device according to claim 15, wherein the one or more instructions, when executed by the processor to estimate whether the second virtual machine is sensitive to the latency, further cause the memory management device to:
obtain core performance measurement unit metrics for the at least one first virtual machine and core performance measurement unit metrics for the second virtual machine,
determine N virtual machines in the at least one first virtual machine that are most similar to the second virtual machine in terms of latency-related information by comparing the core performance measurement unit metrics of the at least one first virtual machine with the core performance measurement unit metrics of the second virtual machine, wherein n is a positive integer, and
determine whether the second virtual machine is sensitive to latency based on determining that a number of the virtual machines having a sensitive to a latency label among the N virtual machines is greater than or equal to a threshold.

17. The memory management device according to claim 15, wherein the one or more instructions, when executed by the processor, further cause the memory management device to:
cluster, in response to the second virtual machine being estimated to be insensitive to latency, data of the second virtual machine stored in local memory a plurality of groups according to a program context and one or more access counts of an application on the second virtual machine, and
store one or more of the plurality of groups with a lowest average number of accesses in a pool memory and/or storing one or more of the plurality of groups with a highest average number of accesses in local memory.

18. The memory management device according to claim 10, wherein the at least one first virtual machine is n virtual machines, among a plurality of first virtual machines for which a memory has been allocated, having memory usage information that is most similar to the memory usage information of the second virtual machine, wherein n is a positive integer, and
wherein the memory usage information of the virtual machine includes one or more of an identity of a customer corresponding to the virtual machine, a type of application corresponding to the virtual machine, a location of the customer, information of the processor specified by the virtual machine, and information of memory specified by the virtual machine.

19. A non-transitory computer-readable storage medium having instructions stored therein, which, when executed by a processor, causes the processor to execute a method comprising:
predicting, based on an unused memory value and/or a latency sensitivity of at least one first virtual machine for which a memory has been allocated, an unused memory value and/or a latency sensitivity of a second virtual machine for which memory is to be allocated, wherein the latency sensitivity of a respective virtual machine indicates whether the respective virtual machine is sensitive to a latency based on whether a latency condition indicating that the respective virtual machine is sensitive to latency is satisfied; and
pre-allocating the memory to be allocated for the second virtual machine based on the predicted unused memory value and/or latency sensitivity of the second virtual machine.

20. The non-transitory computer readable storage medium of claim 19, wherein the predicting the unused memory value and/or the latency sensitivity of the second virtual machine for which the memory is to be allocated further comprises:
determining at least one similarity between (i) memory usage information of the at least one first virtual machine and (ii) memory usage information of the second virtual machine, wherein memory usage information of the respective virtual machine includes one or more of (a) an identity of a customer corresponding to the respective virtual machine, (b) a type of application corresponding to the respective virtual machine, (c) a location of the customer, (d) information of a processor specified by the respective virtual machine, and (e) information of a memory specified by the respective virtual machine; and
predicting the unused memory value and/or the latency sensitivity of the second virtual machine based on the at least one similarity and the unused memory value and/or the latency sensitivity of the at least one first virtual machine.
